(19) United States
(12) Patent Application Publication
(10) Pub. No.: US 2015/0206376 A1
(43) Pub. Date: Jul. 23, 2015

(54) GLOBAL LOTTERY

(71) Applicant: LMS PATENTS (ISLE OF MAN) LIMITED, Isle of Man (GB)

(72) Inventors: John Anthony Reid, Auckland (NZ); James William Piper, Auckland (NZ)

(21) Appl. No.: 14/421,157

(22) PCT Filed: Aug. 9, 2013
(86) PCT No.: PCT/IB2013/056508

§ 371 Date: Feb. 12, 2015

(30) Foreign Application Priority Data
Aug. 15, 2012 (NZ) 601824
Sep. 20, 2012 (NZ) 602537
Oct. 17, 2012 (NZ) 603063
Nov. 16, 2012 (NZ) 603674
Apr. 10, 2013 (NZ) 609252

(51) Int. Cl. G07F 17/32; G06Q 50/34

(52) U.S. Cl. CPC G07F 17/329; G06Q 50/34; G07F 17/3225

(57) ABSTRACT

A computerised lottery system which allows a promoter to run a master lottery and a plurality of sub-lotteries (such as a multi-country lottery with entries from a number of different countries) at the same time. In the case of a multi-country lottery it is possible to allocate a master prize for the multi-country winner as well as a prize for the first ranked entry within a particular country. The system involves ranking all or substantially all entries by computer so that the first ranked entry in the world can be identified as well as the first ranked entry from each country or region having a plurality of entries. The advantage of this system is that the entry price is divided between a country prize pool and a multi-country prize pool, and the percentage allocated to each country's government can vary from country to country.

### FIELD OF THE INVENTION

This invention relates to lotteries and has particular application to large scale lotteries and in particular those where entries are received from a number of different countries.

### BACKGROUND OF THE INVENTION

There are many different lotteries conducted around the world, but the majority of them are limited by geographical area and more often than not are limited within the bounds of a particular country. Many lotteries are State run, and some are conducted by private organisation/s, but licensed by the State. In nearly every case, the State requires that a specified share of the lottery income is allocated either to charitable purposes, or collected by the State as part of its revenue.

Different countries have different rules as to the percentage take required by the State.

It is also apparent that the size of the available prize pool is generally related to the number of potential participants and thus small countries are unable to offer as big a prize as larger countries.

In some cases countries operate lotteries, where the first prize is not always allocated, and the prize pool will increase from lottery to lottery, to create a “jackpot”.

It has been observed that the larger the prize the greater attraction to enter and that in many cases if the jackpot falls below a certain threshold, potential customers become jaded, and are unlikely to enter the lottery.

There is a need to develop a method of operating a lottery which can extend beyond national or jurisdictional borders, and as a consequence offer a larger prize as a result of the greater number of people entering the lottery. Such a trans-national lottery would need to comply with the relevant laws in each country, and more importantly take account of the differing requirements as to revenue sharing operated by different States.

### PRIOR REFERENCES

There have been many attempts to provide systems for managing and operating large scale lotteries including so called “world-wide lotteries”. Examples of prior patents include:

WO 2003/104972 A1 GTECH Rhode Island Corporation

U.S. Pat. No. 6,267,670 Walter Digital, LLC

U.S. Pat. No. 6,277,026 Mci Communications Corporation

WO 2002/027424 A1 Ezlotto Co., Ltd

WO 2002/055165 A1 Marcel Klugman

WO 2005/000436 A1 James Odom et al.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications may be referred to herein; this reference does not constitute an admission that any of these documents form part of the common general knowledge in the art, in New Zealand or in any other country.

### OBJECT OF THE INVENTION

It is an object of the invention to provide an improved lottery and/or an improved method of operating a lottery that would enable it to transcend national boundaries, or one which would at least provide the public with a useful choice.

### STATEMENTS OF INVENTION

In one aspect the invention provides a computerised lottery which allows the promoter to run a master lottery and a plurality of sub-lotteries each of which has a sub-lottery identifier, comprising a plurality of entries with each entry being unique; recording each unique entry and optionally recording at least the identity or contact details associated with each entry; and recording the identifier of the sub-lottery or sub-lotteries associated with that unique entry; randomising the entries and ranking at least sufficient of the entries to allow the allocation of prizes (all or substantially all of the randomized entries); allocating prizes from the master lottery based on the ranking of the entries regardless of which sub-lottery they are associated with; and allocating prizes from each sub-lottery based on the ranking of the entries within each sub-lottery.

By randomising the entries, we mean that the entries from all of the sub lotteries will be jumbled up together and to then form a combined randomised ranking so that the resulting ranking does not bear any relationship to the original order of the entry numbers. There are many ways of taking an original ordered list in each of the sub lotteries to achieve this. For example, the sequential list of entries in each sub lottery could be combined, and then for example using a random number generator, to select entries beginning with a particular digit, using the random number generator to then select the next batch of entries with the second chosen random number, and so on and then applying other randomising processes, so that the original list of sequential entries corresponding to “ticket sales” in each sub lottery has been completely jumbled up or randomised into the master lottery, and at the appropriate time the process can be stopped, and the computer can be interrogated for the resulting ranked list of entries in the master lottery. A search algorithm can then be applied to the resulting ranked list in the master lottery, to determine the highest ranked entry for a particular sub lottery as well as being able to ascertain the highest ranked entry for the entire ranked list which is a combination of all of the sub lottery entries, thereby making up the master lottery.

It will be appreciated that many different randomising processes can be used to generate the resulting ranked list in the master lottery. These can include existing lottery type selection of numbers and then ranking all entries sequentially based on their distance from the randomly chosen set of numbers. For example it can be based on games like LOTTO Strike or LOTTO Bullseye in New Zealand. If duplicates are encountered then an additional process can be applied to rank them in some form of order, preferably a random order using for example a PRNG.

In its simplest form, the randomising process can be considered as analogous to the shuffling of a deck of cards which transforms the deck of cards from an original ordered state into a disordered state (or in some cases into a more disordered state than the original state).

This computerised lottery allows a promoter to run a global lottery (with entries form a number of different countries) and to allocate at least a master prize for the global winner as well as at least a prize for a selected entry within a particular country. The selected entry may typically be the first ranked entry. The advantage of this system is that the entry price is divided between a country prize pool and a global prize pool, and that percentage allocated to each State can vary from country to country.

In another aspect the invention provides a computerised lottery which allows the promoter to run a master lottery and a plurality of sub-lotteries each of which has a sub-lottery identifier, comprising a plurality of entries with each entry being unique; recording each unique entry and optionally recording at least the identity or contact details associated with each entry; and recording the identifier of the sub-lottery or sub-lotteries associated with that unique entry; processing the entries to rank at least sufficient of the entries to allow the allocation of prizes in a randomized list with each ranked entry having a ranking; allocating prizes from the master lottery based on the ranking of ranked entries regardless of which sub-lottery the entries are associated with; and allocating prizes from each sub-lottery based on the ranking of ranked entries within each sub-lottery]

Preferably all or substantially all of the entries are ranked. In practice it will be a simple matter to rank all of the entries first before deciding on the winners of each of the sub-lotteries, rather than stopping the ranking process when each of the sub-lotteries have been won.

Preferably a random number generator is used in a process to process the entries into the randomized list.

Preferably the prizes include a prize for the highest ranked entry in the master lottery (regardless of its sub-lottery identifier) and prizes for the highest ranked entry in each of the sub-lotteries (regardless of their overall ranking in the master lottery).

Preferably a search algorithm is applied to the randomised list, to determine the highest ranked entry within each sub-lottery.

Preferably each entry comprises more than one symbol selected from one or more sets of N symbols, the lottery having a process for ranking symbols to create a ranked list of symbols, then a process for ranking of each entry based on a comparison of (a) the symbols selected per entry with (b) the ranked list of symbols to create the randomized ranked list of at least sufficient of the entries to allow allocation of prizes.

Preferably the entries are analysed to count the number of times each symbol is chosen, and the ranked list of symbols is based on this count.

Preferably a set of entries is received where the set comprises “A” separate entries by the time the lottery is closed, the lottery using a ranking engine to rank at least some of the entries and avoiding two or more entries having an equal ranking, the ranking engine comprising one or more computers for recording entries and ranking the entries and selecting a winner or winners, the computer or computers being capable of: recording each entry and the sub-lottery with which it is associated, and optionally recording at least the identity or contact details associated with each entry and; applying a process that produces a ranked list “C” which cannot be predicted from the identity of each entry, the process allowing ranking of all entries whether or not (a) the process is allowed to run until all entries have been ranked from lowest to highest or (b) the process is stopped after a predetermined time to produce a ranked list “C1” which is less than the full list “C”, or (c) the process is stopped after a set “B” of entries have been ranked (where “B” is less than “A”) to produce a ranked list “C2” which is less than the full list “C”, and applying rules that use the ranked list to determine the winner or winners of the master lottery and each sub-lottery.

Preferably the lottery is a global lottery and each sub-lottery is held within a geographical area, and the rules allow for the award of a prize to the highest ranked entry per geographical area as well as a prize to the highest ranked entry in the world.

Preferably the rules also allow for the award of a prize to the lowest ranked entry per geographical area as well as a prize to the lowest ranked entry in the world.

This preferred version allows a promoter to run a computerised lottery on a global scale with both prizes for the global lottery and prizes for each sub-lottery based on the geographic region of the entries. The system involves ranking all or substantially all entries by computer so that the first ranked entry in the world can be identified as well as the first ranked entry from each country or region having a plurality of entries. The advantage of this system is that the entry price can be divided between a country prize pool and a global prize pool, and that percentage allocated to each State can vary from country to country.

### BRIEF DESCRIPTION OF THE DRAWINGS

FIG. 1 is a diagram of the electronic environment of the invention

FIG. 2 is a block diagram of the functional elements of the invention

FIG. 3 is a flow diagram of the collection of ticket data and the choosing of the successful tickets.

FIG. 4 shows a series of computer print outs (as FIGS. 4a to 4k) relevant to the method of randomising the entries.

FIG. 5 is a flow diagram of entries from multiple countries and the use of a TRNG to randomise the entries list.

### DEFINITIONS

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Master-Lottery—The data set containing all entries in all sub-lotteries, allowing for a prize to the overall winner.

Sub-Lottery—A data set of entries limited by geographic location, membership of a club or society, or limited by some other entry window. The number of entries in a sub-lottery is less than the number of entries in the data set of the Master Lottery.

Global Lottery—A master-lottery where the sub-lotteries are conducted in different countries or regions.

TRNG—True Random Number Generator—whilst it is capable of generating truly random numbers (using an external service such as atmospheric noise) there is a possibility that the TRNG may produce 2 or more numbers that are the same. For a discussion on randomness refer to www.random.org.

PRNG—Pseudo Random Number Generator—these produce unique numbers (no duplicates) but may be predictable.

Lottery—A game of chance including both paid entries for “tickets” and also “prize promotions” where the entry in the lottery or competition involves purchasing a product or service.

Randomising—this means that the entries will be jumbled up together so that the resulting randomised ranking does not bear any relationship to the original order of the entry numbers. There are many ways of taking an ordered list and generating a disordered list which cannot be predicted form the original ordered list. References in the specification to “randomising” or “applying a random sort” are intended to deal with the concept of moving from a first state to a state which is for all practical purposes a more disordered state than the original state. In other words, moving from an ordered or semi-ordered list to a disordered list.

Duplicates—two or more entries having the same identity or ranking. This term does not apply to a class or division of entries which have not been ranked but have been grouped together as in a conventional lottery such as New Zealand LOTTO. In the context of a randomised ranked list there may be some entries having equal ranking, this will be determined by the parameters of the game, and in most cases the parameters will be chosen to minimise the number of entries having equal ranking. It is extremely unlikely that there would be more than 10 entries having the same ranking.

Ticket—Whilst this usually refers to a paper or other printed “ticket number” in the general sense to identify a record which may be stored only in an electronic form. It may or may not include the identification of the entrant.

Bearer Bond—In some countries possession of the printed receipts or “ticket” is sufficient to claim the prize regardless of who originally purchased the “ticket”.

### THE PREFERRED EMBODIMENT(S)

The following description will describe the invention in relation to preferred embodiments of the invention, namely a Global Lottery. The invention is in no way limited to these preferred embodiments as they are purely to exemplify the invention only and that possible variations and modifications would be readily apparent without departing from the scope of the invention.

### Example 1

### It is possible to set up a global lottery using this invention, by using one

or more computers to monitor entries into the lottery, the or each computer being capable of:
Recording each entry preferably by means of a ticket number, although it could be a database record number
Optionally recording the identity or contact details associated with that entry
Recording the group identifier associated with that entry, whether it is the name of the country, the name of a club, the date and time of the entry, or some other identifiable group.

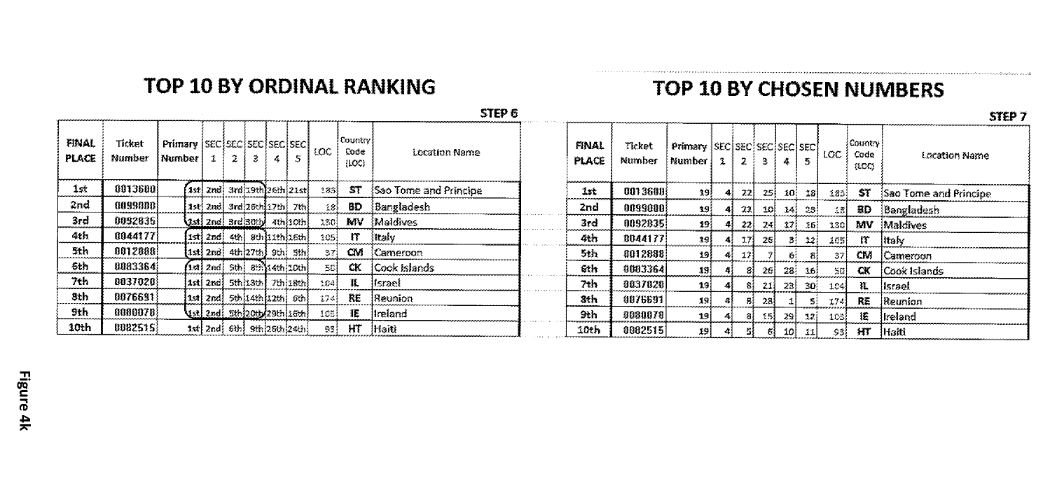

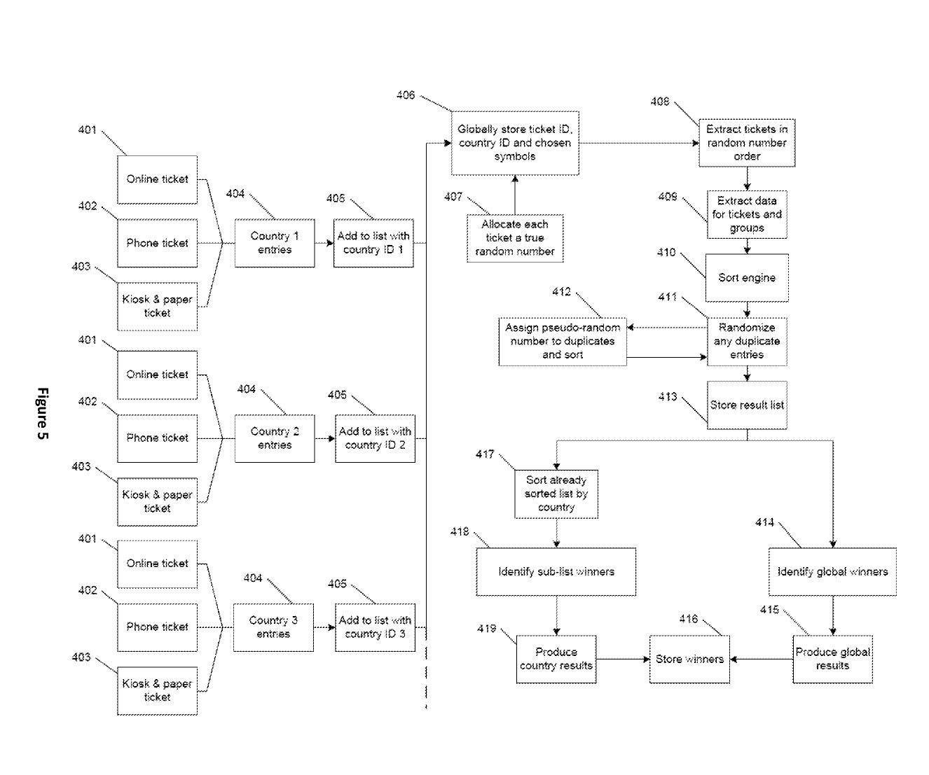

The computer or computers applies a process that produces a randomised but ranked list of all of the entries and from this ranked list applies the rules relating to the allocation of prizes, typically these rules would include:
A first global prize for the first ranked entry in that list, and a series of group prizes, typically this would be the first ranked person for a particular group (i.e. sub-lottery) but may for example include not only the first ranked, but also the last ranked in a particular group, or some number in between. As the group sizes will vary from group to group it is preferable to use the first or last ranked entry or both for each group by recording their position in the randomised but ranked list made up of all or substantially all entries in the global lottery (as that contains entries from all groups). See FIG. 5.

By this means it is possible to operate a master lottery with a number of sub-lotteries. Typically this would be a global lottery, with sub-lotteries for each country. In which case the group information would be the identity of the country where the ticket was purchased. But of course the system could be applied on a smaller scale, for example in the USA the master lottery might be a federal lottery, and the sub-lottery State lotteries, or on a smaller scale again the master lottery might be a lottery within a State, and the sub-lotteries might be linked to a number of State based organisations, it could be a sub-lottery per town or city within that State, or it could be a sub-lottery based on a particular type of social club, or gaming venue. There are an infinite number of possibilities, where there is a master lottery and a plurality of sub-lotteries with each sub-lottery having a “group identifier”.

The system can also be applied to time based lotteries, where a series of sub-lotteries are carried out at different times, for example on different hours or perhaps different days, and all of the entries aggregated into a master lottery, which involves ranking of all of the entries from all of the sub-lotteries. This time based system is less preferable as there is a delay before allocating the master prize, and in its purest form there is a delay in allocating each of the daily prizes, as they are dependent upon the ranking of all of the entries across all of the sub-lotteries.

### Example 2

The ranking process in its simplest form can be based on a ticket or database record number with the computer or computers programmed to conduct a randomising of the ticket numbers so the ticket numbers are jumbled up, and it is preferred that this randomising process would be carried out for a variable length of time preferably controlled by a random number generator so that the final order of the entries sort could not be predicted or influenced by the organisers or the participants.

One of the easiest and fastest ways of randomising a large list of numbers comprising all of the entries from all of the groups making up the master lottery, say for example there are over 500 million entries, would be to use random numbers as the sort field:
1. Master computer allocates a batch of “ticket numbers” to each sub-lottery and records the identity of the sub-lottery against those ticket numbers.
2. Each sub-lottery records relevant information per entry based on the legislation or practice governing that sub-lottery (e.g. bearer bonds or fully identity of the entrant).
3. Each sub-lottery notifies the master computer of any un-sold “ticket numbers”.
4. Unsold ticket numbers are either (a) offered to other sub-lotteries until sold, or (b) deleted from the list of available entries.
5. The lottery is closed (at a predetermined time or when all “tickets” are sold) and the master computer records all entries at least by ticket number or by database record.
6. The master computer then makes use of a true random number generator (TRNG) to allocate and save in a field or column against each entry a true random number.
7. The master computer then sorts the original list of entries from lowest to highest on the random number field to produce a ranked list of entries so that the “ticket number” of the first entry in the list (master-lottery winner) and the highest ranked entry per sub-lottery can be recognised and awarded the relevant sub-lottery prize.
8. In the unlikely event that the TRNG has allocated random numbers of equal value to more than 1 “ticket number”; any equal rankings can be eliminated by using a PRNG to sort those apparently equal ranked “ticket numbers” into an additional ranked but second order randomised list which is then used to change their position (and hence rankings) in the master randomised list.

This process is best understood from the flow diagram of FIG. 5 where entries from a plurality of countries are consolidated and then randomised (sorted using a TRNG to add a randomly generated number to each entry).

Table 1 shows an abridged version of the ranked but randomised list of all entries, showing also the country code associated with these entries. In this example the master lottery is a global lottery with up to 10 million entries, from 0 to 9,999,999.

TABLE 1

| TICKET NUMBER | COUNTRY CODE |
|---|---|
| 7913469 | WS |
| 2788643 | NZ |
| 1861778 | DE |
| 3622743 | GB |
| 3525949 | US |
| 1476973 | AU |
| 8891446 | GB |
| 7777654 | RU |
| 1247631 | US |
| 8488751 | CN |
| 2258944 | US |

This is predicated on a global lottery, where people from different countries can enter the lottery subject to the approval of their Government, and from this lottery it is possible to see the ticket number of the winner of the global prize, and then the ticket number of the first ranked person in each of the sub-lotteries i.e. a lottery for a particular country.

Table 1 shows a brief extract from the randomised ranked list, in this case showing only the top 11 entries after the randomising process has been carried out. It does not matter how the randomising process is carried out, as long as the outcome is not predictable or subject to fraud or interference.

In Table 1 the ticket number 7913469 is both the over-all winner (first ranked in the world) and also the first ranked winner in the Western Samoa (WS) sub-lottery. As will be seen below the global prize pool will be much greater than WS sub-lottery prize pool.

Similarly the US sub-lottery prize pool will be much greater than the WS prize pool (but less than the global prize pool). Ticket number 3525949 wins the US prize pool even through this ticket is the 5^{th} ranked ticket in the world.

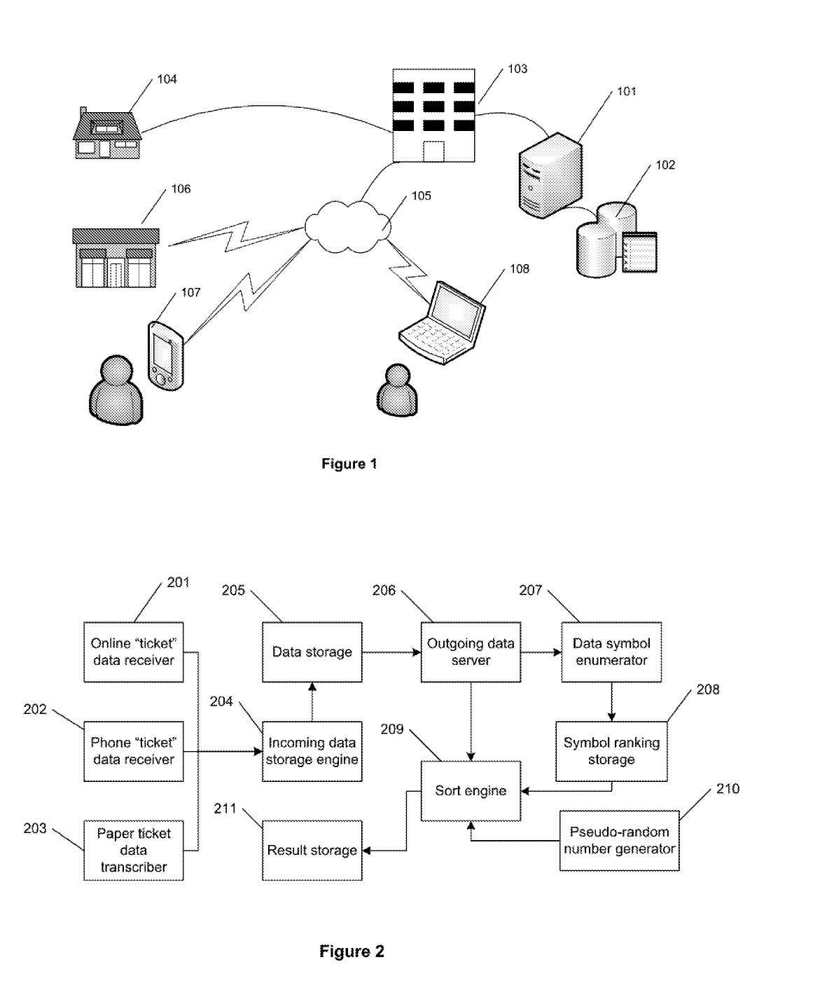

FIG. 1 shows the general environment of the invention where an organisation 103 has a server 101 storing in a database 102 ticket entries from such a home resident 104 connected via telephone to a voice commanded entry at the organisation 103. Equally there may be telephone or internet 105 connected entries from a shop or machine kiosk 106, from mobile users 107 or from static users 108.

When a person wishes to purchase a lottery ticket they can approach a ticket seller, or apply online, or enter via machine kiosks, all of which are preferably connected to a local server for that region. No two tickets numbers should be the same, and thus it is preferable that the ticket numbers are either pre-printed with the numbers being printed sequentially on the different tickets, or that they are stored in the relevant country server, and a ticket number in the sense of a data base record is allocated at that time of purchase of the entry. We have used the word “ticket” as that is readily understood in terms of entries into lotteries, and whilst it would normally apply to a paper ticket or paper entry with a printed number, it is clear that the concept of a “ticket” corresponds to an electronic record in a data base, and thus there are many versions of this invention in which there are no physical paper tickets, simply electronic records of the transaction.

In most cases it will be preferable to have a number or group of numbers within the so called “ticket number” that identifies the country or region involved, as well as making use of the two letter international country code to designate the particular country or region. Similarly if the master lottery is run across a federal territory such as the United States of America, the numerical coding or the alphanumeric coding could refer to entries from different States, as in such countries, the States often operate different rules relating to the percentage take by that particular State. It is also evident that the large more populated States will have more entries, and thus will likely have a larger prize within the State than in a less populated State.

It is preferable also that the ticket number includes a check sum to avoid storage errors, and also to minimise the risk of fraud.

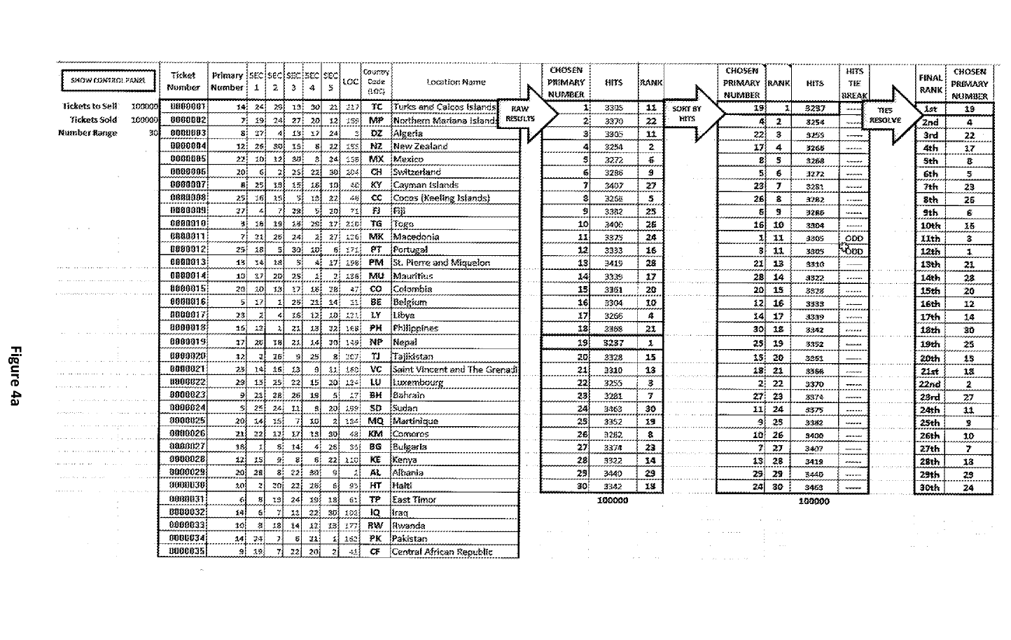

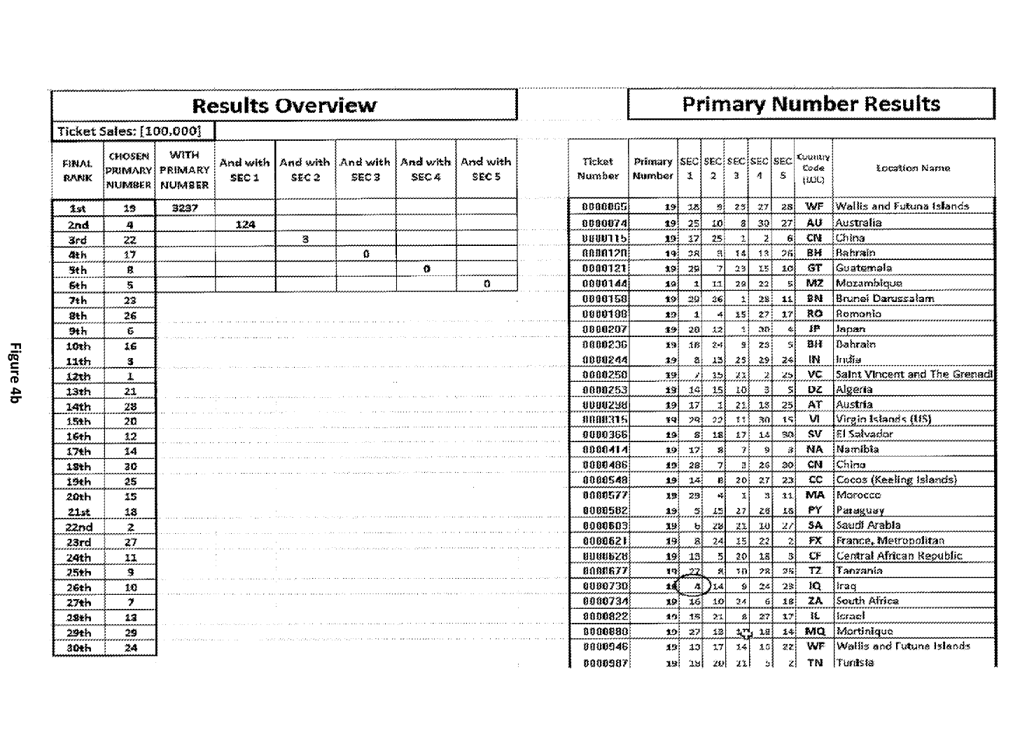

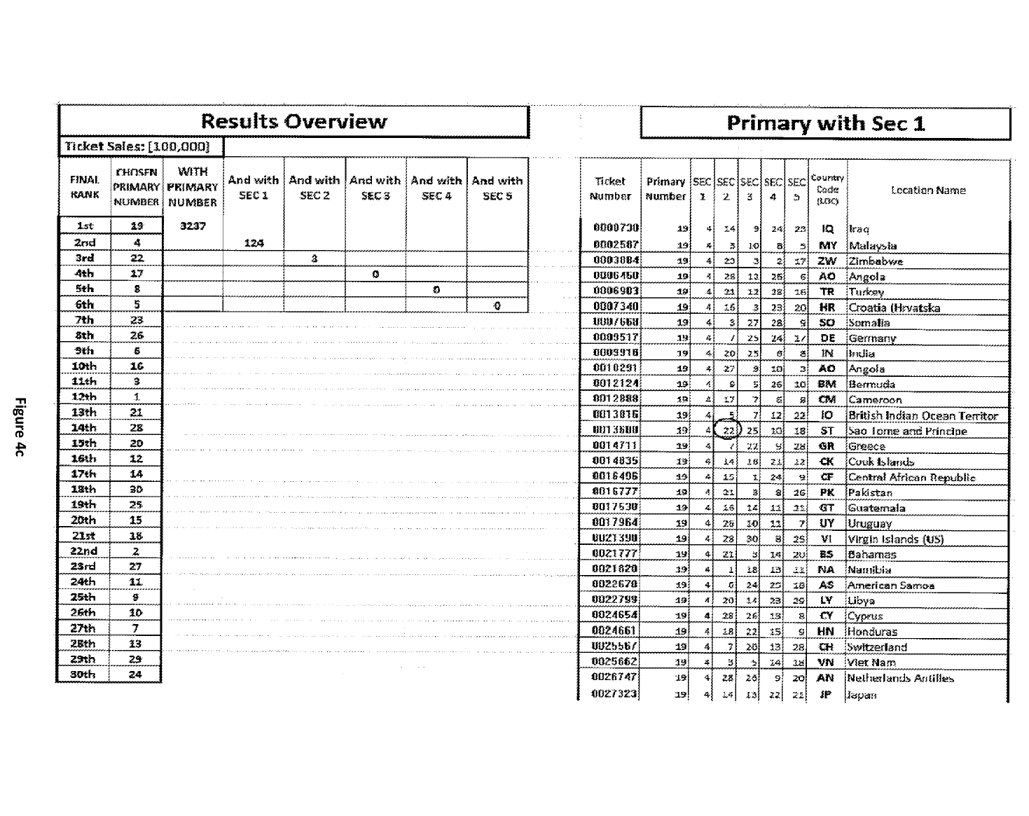

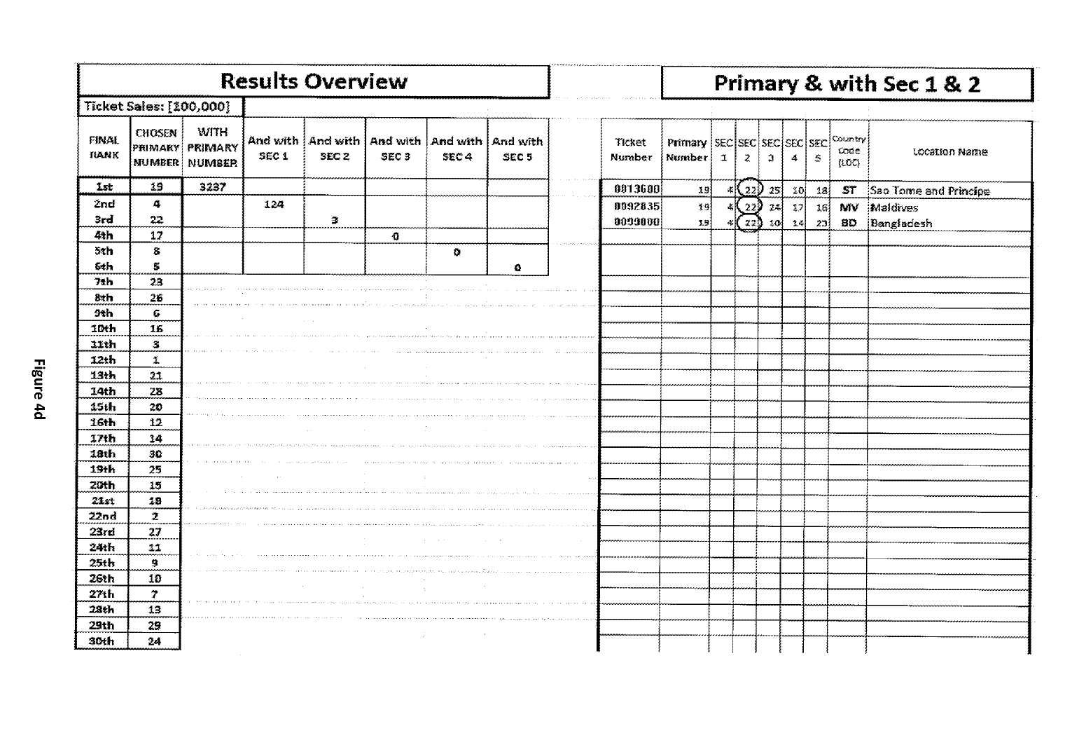

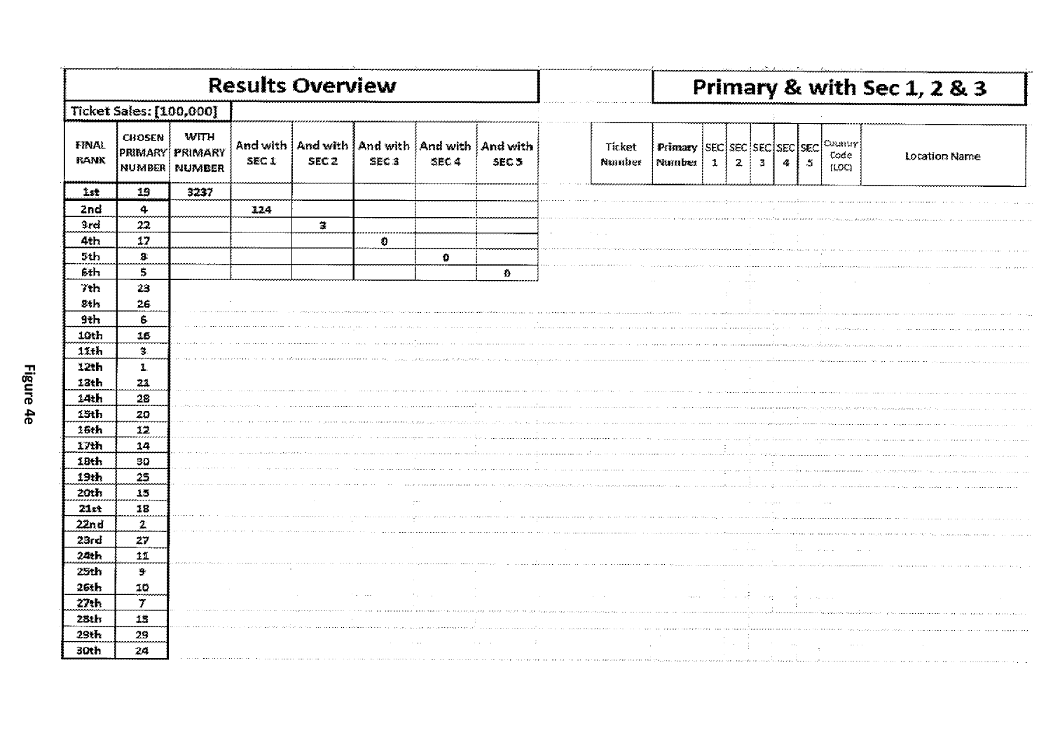

FIG. 2 shows the progress of the ticket or entry details as they are purchased, where at 201 an online customer can enter data and purchase a ticket, including entering or selecting numbers or symbols for the lottery draw. Purchase data passes to a central location where an incoming data storage engine 204 passes the data to data storage 205, including group data which is typically country or state data identifying the purchase location.

In similar manner a phone customer 202 can select data for a ticket using a voice directed phone system before the information is passed to the storage engine. A customer buying a ticket at a retail establishment 203 can similarly choose their own symbols or numbers or accept a machine chosen set of symbols or numbers before completing a transaction which sends the chosen data to data storage.

In this case of choosing a set of symbols or numbers, the randomising process is based on the interaction of the entries by allowing each entrant to choose say 6 numbers out of 40 (x out of y). Then ranking each of the [40] symbols or numbers that were available to be chosen on the basis of the least picked symbol/number to the most picked symbol/number, or ranking the [40] symbols or numbers (or at least a sufficient number of them) by a random means such as a random order of draw. As will be explained below this can be used to then rank all of the entries against each other entry.

Once the lottery closes the information in the data store can be frozen and at the draw time the data transferred through an outgoing data server at 206 to a data symbol enumerator 207. The enumerator 208 counts each occurrence of a symbol or number as chosen by the customer and transfers this count to a storage space for the symbol ranking.

The complete set of entries is then sorted at a sort engine 209 which ranks the entries symbol by symbol, using as a basis the symbol ranking stored in symbol ranking storage 208, to arrive at a listing in which each ticket or entry is ranked against each other entry.

Since it is entirely possible that there will be entries which entirely duplicate the symbols and the order in which they were entered there is a pseudo-random number generator (“PRNG”) 210 which can additionally sort the entries to resolve such duplication. This sort may be carried out either on completion of the ranking sort or before the ranking sort is commenced.

Once the final result of the ranking is available it is stored in result storage 211.

### Example 3

A lottery based just on a ticket number is not as interesting or as exciting as one in which the participants have a degree of choice. For example in a conventional State lottery the participants would choose say 6 numbers out of 40, and the selection might be made by the random selection of numbered balls at the end of the lottery. Such a conventional State lottery does not lend itself to the creation of a master lottery and sub-lotteries, as the participants are not ranked; instead a number of divisions are set up based on how close a participant's entry was to the numbers randomly selected by the machine.

A much better way of conducting a master lottery and sub-lotteries is to make use of our co-pending invention, in which we allow a participant to choose say 6 numbers out of 20 and then set up a ranking list of the 20 numbers (Ranking List), the order of the numbers in the Ranking List being based on the amount of times each number was selected on or in the entries with the first ranked number being the number that was least picked, and so on with the most picked number being ranked last on the Ranking List. Alternatively, the order in the Ranking List could be determined by some random method, such as a random draw of the 20 numbers. Then, from that resulting Ranking List, it is possible to look at each of the entries and to rank these entries based on a set of rules.

The contents of our co-pending New Zealand and PCT specifications, all of which claim priority from a number of provisional patent applications commencing with our originating NZ application #601824 on 15 Aug. 2012, are incorporated herein by way of reference. The NZ application numbers include 601824, 602537, 603063, 609252 and 609589.

By using the co-pending ranking system it is possible to provide the system with means to accommodate differing payout requirements of various countries or regions.

The gaming system's unique advantages include that each number or symbol in the range of numbers from 1 to n that can be chosen by participants is ascribed a unique and individual ranking number, or ranking value or placement value, to form what we call the Ranking List. From the combination of numbers or symbols chosen with each entry and their place in the Ranking List, it is possible to provide a near unique rank within all the entries. Naturally if two entries have the same number or symbols in the same places some other resolving method is needed to provide a unique rank.

Consequently, each participant in a game utilizing the co-pending gaming system described therein, including each participant in a regional or worldwide game, can be individually placed in the game, from first place to last place in respect of the overall game, or in respect of that participants performance within a subset of participants, such as the placement from first place to last place among only the participants who entered the game from Country A, or alternatively, and separately, the placement from first place to last place among only those participants that entered from Country B, and so on.

This capability of the invention enables the regional or worldwide game organizers to identify, from the one set of gaming data from the regional or worldwide game, not only the overall winner/s of any regional or worldwide game, but also the local area or local country winners—to whom a local area or local country prize can be provided.

This provides a means to accommodate differing payout requirements of gaming operators in various countries or regions (often imposed upon a licensed gaming operator by their respective government) in a way that is advantageous to the formation and running of a regional or worldwide game or lottery, as described below.

### Example 3.1

### Assumed Game or Lottery Profile with a Region Comprising 3 Countries

The assumptions below are provided for illustration purposes and assume that there are three countries (hereafter referred to as Country A, Country B and Country C) cross selling a regional game or lottery using the gaming system of the invention.

An example of how Country A, B and C have different requirements relating to the amount of revenues to be returned to them, and how this difference can be accommodated through the use of the gaming system described herein and the payment of the local country prize, is set out in Table 2:

TABLE 2

| Allocation to: | Country A | Country B | Country C |
|---|---|---|---|
| Prizes paid by the regional or | 45% | 45% | 45% |
| worldwide game or lottery | | | |
| The Relevant Local Country Operator | 55% | 55% | 55% |
| Additional Local Country Prize | 0% | 10% | 5% |
| (Country variable) | | | |
| Decided and paid by Relevant Local | | | |
| Country Operator | | | |
| Net to the Relevant Local Country | 55% | 45% | 50% |
| Operator | | | |

In this Example 3, to demonstrate how the regional game/lottery works utilizing the gaming system and methods described herein, it is assumed that:
A regional game or lottery is sold by three countries, relevantly Country A, Country B and Country C;
The participants purchasing tickets within each of the three countries will each purchase 6 different numbers in the selected range of say 1-30;
Each number block of 6 numbers, consists of 1 PRIMARY and 5 SECONDARY numbers, each of which must be different;
Each number block is purchased at a total cost of $10;
The regional lottery is played by 500,000 participants, with:
300,000 participants from Country A; (60%)
150,000 participants from Country B; (30%) and
50,000 participants from Country C. (10%)
Each participant purchasing tickets within each of the three countries purchases the minimum of $10 for one number block of 6 different numbers—so there would be 500,000 PRIMARY numbers picked in total, all in the number range of 1-30;
Thus the total revenue from the regional game/lottery is $5,000,000;
The prize pool payable by the regional game/lottery is set at 45% of total revenue,
Thus, there being prizes of $2,250,000 to be paid by the regional game/lottery organizers;
The amount of revenues to be paid to Countries A, B and C is therefore 55% of the total revenue, which is a combined total of $2,750,000.
Country A, Country B and Country C each receive 55% of the sales revenues attributed to their respective sales achieved within their own country. Relevantly, in this example:
Country A gets $1,650,000 ($2,750,000×60%)
Country B gets $825,000 ($2,750,000×30%)
Country C gets $275,000 ($2,750,000×10%)
In this example, there are restrictions on who can receive a local country prize. In this example the restriction is that the local country prize can only be paid by a country to a country's citizen, or resident, or to a person that can prove he/she was in the country at the time of the ticket's purchase. Other restrictions are possible.

TABLE 3
Results of 500,000 Participant Regional Game/Lottery

| BY RANKINGS | | | BY NUMBERS | | |
|---|---|---|---|---|---|
| RANK- | | | | | RANK- |
| INGS | NUMBER | | | NUMBER | INGS |
| OF | OF | NUM- | NUM- | OF | OF |
| LEAST | TIMES | BERS | BERS | TIMES | LEAST |
| PICKED | CHOSEN | CHOSEN | CHOSEN | CHOSEN | PICKED |
| 1 | 12,000 | 13 | 1 | 14,063 | 8 |
| 2 | 12,002 | 30 | 2 | 19,000 | 21 |
| 3 | 13,335 | 21 | 3 | 14,400 | 10 |
| 4 | 13,775 | 4 | 4 | 13,775 | 4 |
| 5 | 13,999 | 27 | 5 | 20,789 | 29 |
| 6 | 14,005 | 10 | 6 | 19,441 | 25 |
| 7 | 14,010 | 20 | 7 | 18,888 | 20 |
| 8 | 14,063 | 1 | 8 | 17,650 | 18 |
| 9 | 14,065 | 11 | 9 | 19,442 | 26 |
| 10 | 14,400 | 3 | 10 | 14,005 | 6 |
| 11 | 15,050 | 25 | 11 | 14,065 | 9 |
| 12 | 15,556 | 16 | 12 | 16,021 | 16 |
| 13 | 15,900 | 24 | 13 | 12,000 | 1 |
| 14 | 16,005 | 29 | 14 | 20,543 | 28 |
| 15 | 16,008 | 19 | 15 | 19,347 | 23 |
| 16 | 16,021 | 12 | 16 | 15,556 | 12 |
| 17 | 17,000 | 18 | 17 | 21,345 | 30 |
| 18 | 17,650 | 8 | 18 | 17,000 | 17 |
| 19 | 17,775 | 26 | 19 | 16,008 | 15 |
| 20 | 18,888 | 7 | 20 | 14,010 | 7 |
| 21 | 19,000 | 2 | 21 | 13,335 | 3 |
| 22 | 19,023 | 28 | 22 | 20,189 | 27 |
| 23 | 19,347 | 15 | 23 | 19,374 | 24 |
| 24 | 19,374 | 23 | 24 | 15,900 | 13 |
| 25 | 19,441 | 6 | 25 | 15,050 | 11 |
| 26 | 19,442 | 9 | 26 | 17,775 | 19 |
| 27 | 20,189 | 22 | 27 | 13,999 | 5 |
| 28 | 20,543 | 14 | 28 | 19,023 | 22 |
| 29 | 20,789 | 5 | 29 | 16,005 | 14 |
| 30 | 21,345 | 17 | 30 | 12,002 | 2 |
| | 500,000 | | | 500,000 | |

Table 3 (above) and the tables below set out a sample of results for a set of entries on the following basis:
Any numbers in the range of 1-30 not chosen by any participant are ignored.
The number 13 is the PRIMARY number that is chosen the least by all the 500,000 participants in the regional or worldwide game or lottery.
There are 12,000 participants that have chosen 13 as their PRIMARY number.
Ties between the n numbers in the number range 1 to 30 are ALL resolved using the methods either as in the originating application or as set out later.
Table 3 above sets out the results of this example regional game or lottery with 500,000 participants, and shows the number of times each number in the 1-30 number range was chosen by all the participants in the regional game or lottery.
The 12,000 winners who all chose number 13 as their PRIMARY (first) number choice are subjected to further eliminations using the SECONDARY numbers, which are conducted using the one data set from the 500,000 participant's choices of the PRIMARY number.

### Example 3.2

### The Elimination Processes

The First Eliminations:

The first elimination process involves a computer analysis reducing the participants in the regional game from 500,000 to a much lower number. This occurs by eliminating all participants other than those participants that chose number [13] as their PRIMARY number. The number [13] is the number in this example that was least picked by all the 500,000 participants in the regional game, as it was chosen 12,000 times—see Table 3 (first line).

Calculations:

With 500,000 participants in the regional game, divided by the number range of 1-30, this results in an average of 16,666 participants per number. Of course, some numbers will be chosen more times, other numbers less. In this example, it is assumed that there are 12,000 participants that have chosen[13] as their PRIMARY number and which, therefore, are not eliminated.

The Second Eliminations:

The second elimination process involves a further computer analysis which reduces the remaining 12,000 participants from 12,000 to a much lower number by eliminating all participants other than those participants that chose number [30] as their 1^{st} SECONDARY number. The number [30] is the number that was the second least picked number by all the 500,000 participants in the regional game, as it was chosen 12,002 times—see Table 3 (second line).

Calculations:

With 12,000 participants remaining in the regional game, divided by the remaining number range of 29 (as number 13 has now gone from the number range of 1-30), results in an average of 414 participants per number. Of course, some of the remaining 29 numbers will be chosen more times, other numbers less. In this example, it is assumed that there are about 400 participants that have chosen[30] as their 1^{st} SECONDARY number and which are, therefore, not eliminated.

The Third Eliminations:

The third elimination process involves a computer analysis which reduces the remaining c. 400 participants by eliminating all participants other than those that chose [21] as their 2^{nd} SECONDARY number. The number [21] is the number that was the third least picked by all the 500,000 participants in the regional game, as it was chosen 13,335 times—see Table 3 (third line).

Calculations:

With c. 400 (about 400) participants remaining in the regional game, divided by the remaining number range of 28 (as number 13 and 30 have both now gone from the number range of 1-30), results in an average of c. 14 participants per number. Of course, some of the remaining 28 numbers will be chosen more times, other numbers less. In this example, it is assumed that there are c. 10 participants that have chosen[21] as their 2^{nd} SECONDARY number and which are, therefore, not eliminated.

Final Eliminations—the Ranking System:

With c. 10 participants remaining in this example, those small number of remaining participants can be ranked using their 3^{rd} SECONDARY number, and 4^{th} SECONDARY number if necessary, to determine the winner/s.

This above described process is exemplified in Table 5 that follows, which focuses on the 10 best performing participants in the regional game/lottery. When considering Table 5, the 6 number choices of the best 10 performing participants (having the best results for the ‘least picked’ PRIMARY number and 5 SECONDARY numbers) are set out in Table 4 below:

TABLE 4
Chosen numbers of the Top 10 Participants
in Regional Game/Lottery

| | Primary | | | | | |
|---|---|---|---|---|---|---|
| Participant | Number | 1^{st} SEC | 2^{nd} SEC | 3^{rd} SEC | 4^{th} SEC | 5^{th} SEC |
| P.1 | 13 | 30 | 21 | 4 | 20 | 2 |
| P.2 | 13 | 30 | 21 | 4 | 3 | 11 |
| P.3 | 13 | 30 | 21 | 27 | 10 | 20 |
| P.4 | 13 | 30 | 21 | 11 | 18 | 20 |
| P.5 | 13 | 30 | 21 | 11 | 8 | 26 |
| P.6 | 13 | 30 | 21 | 16 | 25 | 20 |
| P.7 | 13 | 30 | 21 | 24 | 4 | 10 |
| P.8 | 13 | 30 | 21 | 29 | 27 | 4 |
| P.9 | 13 | 30 | 21 | 19 | 26 | 3 |
| P.10 | 13 | 30 | 21 | 12 | 2 | 1 |

TABLE 5
Determine the winner of the Regional Game or Lottery (the winning process is shaded, underlined and bolded):

| | Nos. of Participants From PRIMARY no. 13 | | | | | | | | | | |
|---|---|---|---|---|---|---|---|---|---|---|---|
| | | | | | | | | | | | . . . To P. |
| | P.1 | P.2 | P.3 | P.4 | P.5 | P.6 | P.7 | P.8 | P.9 | P.10 | 12,000 |
| Country or | C | A | A | B | A | A | A | B | A | A | |
| Region of | | | | | | | | | | | |
| participants | | | | | | | | | | | |
| Country or | Yes | No | No | Yes | No | No | No | Yes | No | No | |
| Region | | | | | | | | | | | |
| electing a local | | | | | | | | | | | |
| country or | | | | | | | | | | | |
| region prize | | | | | | | | | | | |
| First | 12,002 | 12,002 | 12,002 | 12,002 | 12,002 | 12,002 | 12,002 | 12,002 | 12,002 | 12,002 | c. 400 |
| Secondary | | | | | | | | | | | left |
| (no of times | | | | | | | | | | | |
| chosen by all | | | | | | | | | | | |
| participants in | | | | | | | | | | | |
| lottery) | | | | | | | | | | | |
| 2^{nd} Secondary | 13,335 | 13,335 | 13,335 | 13,335 | 13,335 | 13,335 | 13,335 | 13,335 | 13,335 | 13,335 | c. 10 |
| | | | | | | | | | | | left |
| 3^{rd} Secondary | 13,775 | 13,775 | 13,999 | 14,065 | 14,065 | 15,556 | 15,900 | 16,005 | 16,008 | 16,021 | |
| | | (2^{nd}) | (3^{rd}) | | | (6^{th}) | (7^{th}) | (8^{th}) | (9^{th}) | (10^{th}) | |
| 4^{th} Secondary | 14,010 | 14,400 | 14,005 | 17,000 | 17,650 | 15,050 | 13,775 | 13,999 | 17,775 | 19,000 | |
| | (1^{st}) | | | (4^{th}) | (5^{th}) | | | | | | |
| 5^{th} Secondary | 19,000 | 14,065 | 14,010 | 14,010 | 17,775 | 14,010 | 14,005 | 13,775 | 14,400 | 14,063 | |
| Extra Nos. | . . . | . . . | . . . | . . . | . . . | . . . | . . . | . . . | . . . | . . . | |
| if needed | | | | | | | | | | | |

### Example 3.3

### Determining the Regional Winner's Explained

As can be seen from Table 5 above, participants P.1 and P.2 have each picked the same number for the primary number and 1^{st}, 2^{nd} and 3^{rd} SECONDARY numbers and in each case this is the number least picked. No other player has matched this. However once the least picked 4^{th} SECONDARY number is considered, participant P.1 has the least picked number and becomes the winner of the regional game/lottery. Participant P.2 becomes the 2^{nd} placed participant. The 4^{th}, 5^{th} and 6^{th} placed participants, and so on are determined in a like manner.

P.1 is the sole winner of the regional game/lottery. Further as P.1 is a participant from Country C which is paying out a local country prize, P.1, in this example, also wins the local country prize provided P.1 meets the restrictions such as being a citizen or resident of Country C, or being able to prove that P.1 was in Country C at the time P.1 purchased the ticket.

### Example 3.4

### Local Country Prizes

The above illustrated example in Table 5, utilizing the computer division (by elimination) and ranking system, also shows the country (relevantly Country A or B or C) from which the lottery winners came from, and it shows the top 10 ranked participants in order.

In this Example 3, there are only three countries (Country A and Country B and Country C) participating in the regional game or lottery, and only Country B and C have elected to pay a local country prize. In this exampled case, that local country prize is:
10% to be paid by Country B of the revenues attributed to Country B (which were 30% of all the sales in the regional lottery—relevantly a local country prize of $150,000)
5% to be paid by Country C of the revenues attributed to Country C (which were 10% of all the sales in the regional lottery—relevantly a local country prize of $25,000)

If Country B and C both elected the local country prize to be paid only to one ticket holder, being its ‘local country winner’—then in the above example, the local country winner for Country B is participant P.4 who gets paid a local country prize of $150,000, and for Country C it is participant P.1 who gets paid a local country prize of $25,000.

While Table 5 sets out only the top ten participants overall from the regional or worldwide game/lottery, it is recognized that not all local country winners may initially feature in the final results. Because of the computer ranking system, and the use of the one data set, the winner of each local country prize can also be determined by the regional gaming or lottery operator and advised to the relevant parties.

As will be evident from the various examples showing the use of the invention set out herein, and using the one set of data results determined by the regional or worldwide game (i.e. relevantly for this Example 3, the one set of data and the ranking system as set out in Table 3), the invention using the computer division (by eliminations) and ranking systems, can be run in respect of the participants for each country so as to identify local country winners and other rankings such as 2^{nd}, 3^{rd}, and so forth even down to the last ranked participant from each country.

Further, the invention allows for the regional game or lottery of the present invention, or the local country winner aspect of the game, or both, to incorporate a worst result prize e.g. the participant with the PRIMARY number and one or more of the 5 SECONDARY numbers that had been picked the most by all the participants in the lottery could be readily identified. That relevant participant with the worst result could be paid a prize for that worst result.

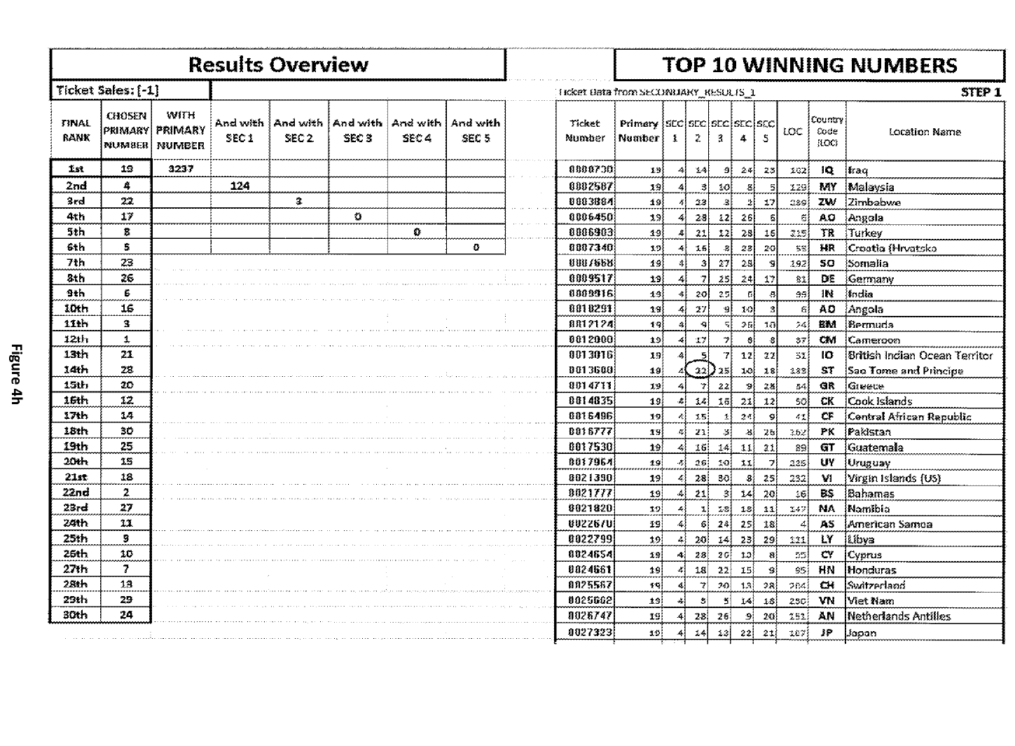

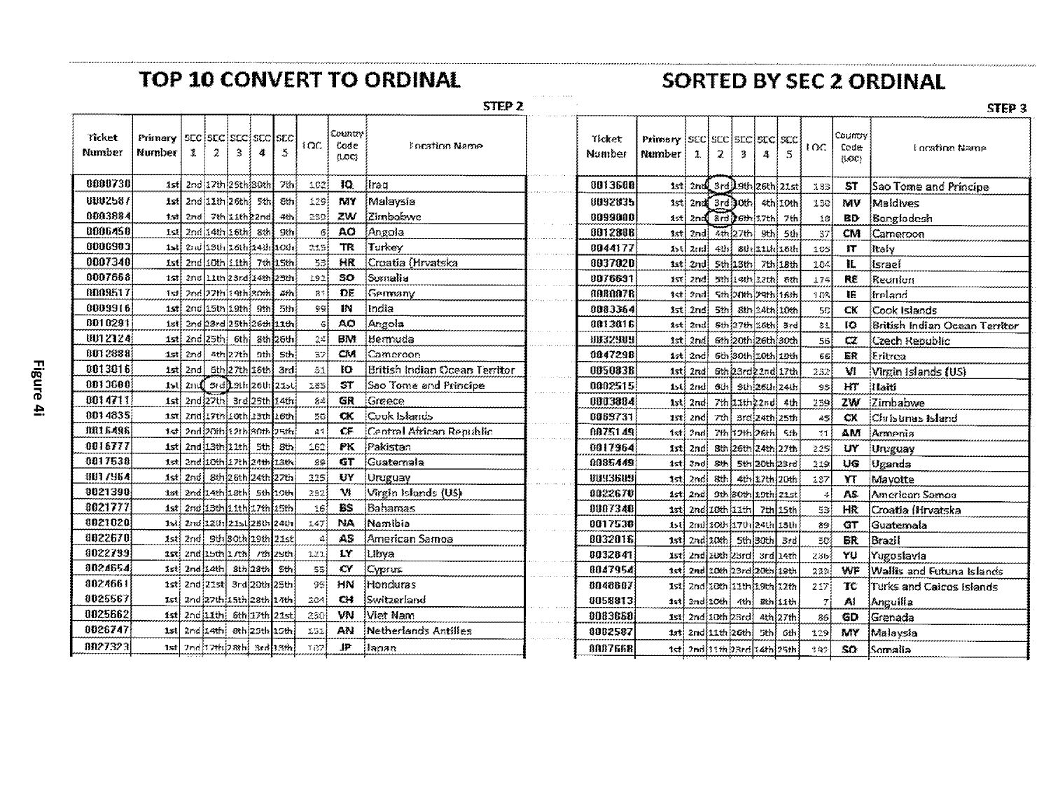

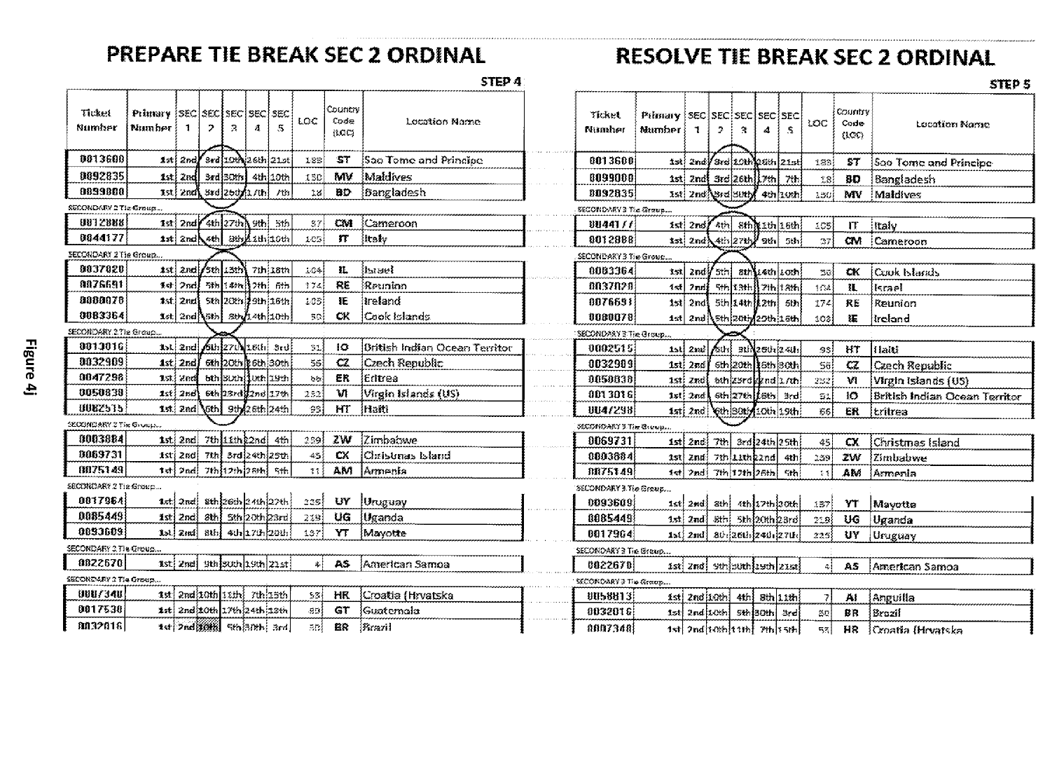

FIG. 4 shows, by way of an example in a series of computer printouts (sheets 4a to 4k), a method of processing by a computer the results for a 100,000 participant game. In particular FIG. 4 shows a method by which the computer processing determines the top 10 in order, from which the winner of a regional or worldwide game can be determined. FIG. 4 also records the relevant country. The operation of a control panel requiring the relevant country to be inserted (although not shown) identifies the local country winner. This example set out in FIG. 4 can be easily scalable for any size game.

### Example 4

### Other Applications, Including in Respect of ‘Standard’ LOTTO

As will also be evident to persons skilled in this art, there will be variations on the methods described above. For example, the use of the invention in respect of ranking and ordering all the n numbers in the range of numbers from one to n that are available for selection by participants in a ‘standard’ LOTTO game will also allow for a local country winner/s prize, or the identification of the worst result.

A ‘standard’ LOTTO game as referred to in this Example 4 is one where players pick a set of numbers, say 6 numbers, from a larger range of n numbers, say from 1-49, the object being for a participant to match the 6 numbers that will later be drawn from the larger range of n numbers by the lottery operator. Once the lottery operator conducts the ‘standard’ lottery draw and draws the 6 numbers, the other 43 numbers in the ‘standard’ lottery are of no effect and have no ranking value.

If such a ranking or ordering system were to be adopted and applied to all numbers that are available to be chosen in a ‘standard’ LOTTO type game (in this example, a unique ranking of all the 49 numbers), then this would enable lottery organizations to utilize the invention and methods described and exampled herein, including in relation to using a standard LOTTO game in a regional or worldwide lottery cross sold by two or more lottery operators in which other winners can also be determined, such as a local country winner/s, or a local country worst result winner.

### Example 5

### Revised Ranking Method

There are many ways of producing a randomised list. Another simple way of achieving this end is to close the lottery then to use a true random number generator to generate a random number having the same number of digits as the ticket numbers.

Using the example of Table 1 the ticket numbers could be 7 digit numbers. If the chosen random number is for example 1513466 then the ticket closest to that number is the Australian ticket 1476973 which would then be the first ranked entry. The closest to the random number is simply the result of subtracting each number from the random number (ignoring the sign—i.e. whether the result is positive or negative) then storing and ranking these results from lowest to highest. This system may generate some duplicate rankings. They could be kept as equal rankings or a further process applied to further sort them based on an arbitrary rule, or using a PRNG or similar process.

### Example 6

### Least Picked Symbols and Random Number Used as a Tie Breaker

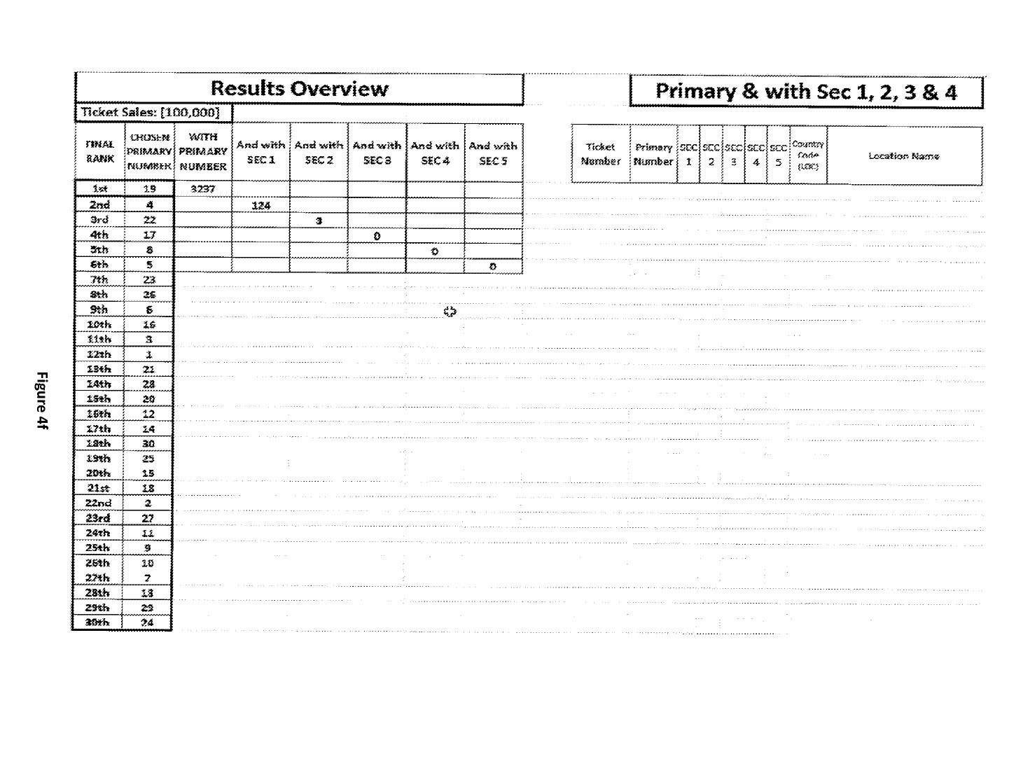

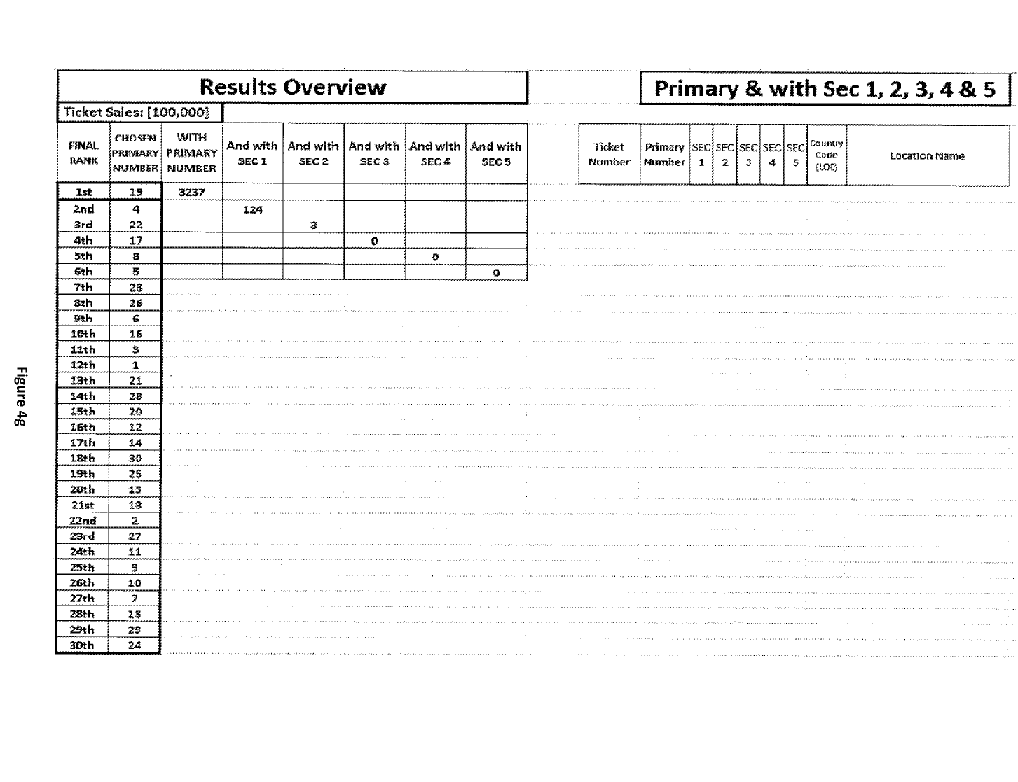

FIG. 3 shows the process to be followed in purchasing the entries or tickets and the process followed at the draw to produce a result.

At 301 a customer may purchase a ticket, whether this is a paper ticket from a retailer or an online entry producing for the customer a permanent record of the entry. The entry may include numbers or symbols specifically chosen by the customer or these symbols may be randomly chosen by one of the well-known methods at purchase.

The ticket or entry purchased has at least a unique identifier plus the numbers or symbols chosen by the customer or the retailing system and these are sent to a central location 302 to be stored. Also stored is the group data for each entry, which may be used to identify the country or state in which the entry was purchased.

When the lottery closes the draw may be carried out by extracting from the data store the data for the entries or tickets and the ticket groups at 304. The number of times each symbol or number occurs in all the tickets in any position is then counted at 305 and this produces an occurrence list of the symbols which is the “symbol ranking” for the draw. The ranking may be either ascending or descending in order of the count of each symbol, but would normally be in descending order.

Each entry or ticket is then assigned a random number at 307, to provide data which can be used to separate two entries where the symbols are duplicates of each other. Typically the random numbers are pseudo-random numbers from a repetitive sequence which is at least ten times larger than the count of all entries. The “seed” for the pseudo-random sequence may be known so that the sequence can be repeated for forensic purposes if required. The entries are then sorted by this random number at 308.

Following this the entries are successively sorted at 309 and 310 by each symbol position using a version of the “symbol ranking” which rolls by one symbol each time as shown in Table 3. It is irrelevant which symbol position is sorted first or last, but typically the sort can be carried out to show what is considered to be the most spectacular effect by a viewer of the evolving results.

The complete list of entries or tickets can now have the top ticket identifiers listed as receiving prizes at 311 and additionally the already sorted list can be sorted by the group identifier (typically country or state) at 312 and the top ticket identifiers for each of these listed at 313. The lotteries results can then be produced at 314.

Advantages

The ranking of all (or substantially all) the entries allows allocation of a master prize as well as a number of sub-lottery prizes, and this system allows different States to take different percentage of the take for their country or region. In practice it is sensible to rank all valid entries after excluding any un-sold “tickets”, so that the published rules of the game (typically a lottery or prize promotion) allows for prizes to be allocated based on the final ranking of the entries after the randomising process has been completed.

Variations

Various methods of randomising entries have been described. The invention allows for the transformation from entries in any order (typically but not necessarily an ordered list) into a disordered list where the individual rankings of entries in the disordered list cannot be predicted. There will be many ways of achieving this objective, whether it involves sorting using a database, a spreadsheet, or a program especially designed to randomise entries in a lottery. It will be appreciated that the invention is not limited to any particular randomising process, and that any way of creating a randomised but ranked list can be used to achieve the objective of the invention.

Although it is preferable to resolve any duplicate rankings it is equally possible that the lottery can allow for a number of duplicate rankings. In this context duplicate entries are multiple entries having the same ranking. Resolving duplicate entries can be achieved by applying a second order process to ensure each entry has a unique ranking. This could include withdrawing any duplicate rankings from the lottery or by applying an arbitrary rule or rules to sort or shuffle the duplicates into a new ranking. It is equally possible that the lottery can allow for a number of duplicate rankings.

The Invention may also broadly be said to consist in the parts, elements and features referred or indicated in the specification, individually or collectively, and any or all combinations of any of two or more parts, elements, members or features and where specific integers are mentioned herein which have known equivalents such equivalents are deemed to be incorporated herein as if individually set forth.

The examples and the particular proportions set forth are intended to be illustrative only and are thus non-limiting.

The invention has been described with particular reference to certain embodiments thereof. It will be understood that various modifications can be made to the above-mentioned embodiment without departing from the ambit of the invention. The skilled reader will also understand the concept of what is meant by purposive construction.

### INDUSTRIAL APPLICABILITY

The invention provides a computerised system for operating a master lottery and a number of sub-lotteries and the sharing of the prize pool between the sub-lotteries and the master lottery. This enables it to be used to operate a global lottery transcending national or state borders.

1-10. (canceled)

11. A computerized lottery which allows the promoter to run a master lottery and a plurality of sub-lotteries each of which has a sub-lottery identifier, comprising a plurality of entries with each entry being unique; recording each unique entry and optionally recording at least the identity or contact details associated with each entry; and recording the identifier of the sub-lottery or sub-lotteries associated with that unique entry; processing the entries to rank at least sufficient of the entries in a randomized list, with each ranked entry having a ranking, to allow the allocation of prizes; allocating prizes from the master lottery based on the ranking of ranked entries regardless of which sub-lottery the entries are associated with; and allocating prizes to one or more entries from each sub-lottery based on the ranking of ranked entries within each sub-lottery.

12. A computerized lottery as claimed in claim 11, wherein all or substantially all of the entries are ranked.

13. A computerized lottery as claimed in claim 12, wherein a random number generator is used to process the entries into the randomized list.

14. A computerized lottery as claimed in claim 13, wherein the prizes include a prize for the highest ranked entry in the master lottery regardless of its sub-lottery identifier and prizes for the highest ranked entry in each of the sub-lotteries regardless of their overall ranking in the master lottery.

15. A computerized lottery as claimed in claim 14 wherein a search algorithm is applied to the randomised list, to determine the highest ranked entry within each sub-lottery.

16. A computerized lottery as claimed in claim 11, wherein each entry comprises more than one symbol selected from one or more sets of N symbols, the lottery having a process for ranking symbols to create a ranked list of symbols, then a process for ranking of each entry based on a comparison of (a) the symbols selected per entry with (b) the ranked list of symbols to create the randomized ranked list of at least sufficient of the entries to allow allocation of prizes.

17. A computerised lottery as claimed in claim 16, wherein the entries are analysed to count the number of times each symbol is chosen, and the ranked list of symbols is based on this count.

18. A computerised lottery as claimed in claim 1, wherein a set of entries is received where the set comprises “A” separate entries by the time the lottery is closed, the lottery using a ranking engine to rank at least some of the entries and avoiding two or more entries having an equal ranking, the ranking engine comprising one or more computers for recording entries and ranking the entries and selecting a winner or winners, the computer or computers being capable of:
recording each entry and the sub-lottery with which it is associated, and optionally recording at least the identity or contact details associated with each entry and;
applying a process that produces a ranked list “C” which cannot be predicted from the identity of each entry, the process allowing ranking of all entries whether or not (a) the process is allowed to run until all entries have been ranked from lowest to highest or (b) the process is stopped after a predetermined time to produce a ranked list “C1” which is less than the full list “C”, or (c) the process is stopped after a set “B” of entries have been ranked (where “B” is less than “A”) to produce a ranked list “C2” which is less than the full list “C”, and applying rules that use the ranked list to determine the winner or winners of the master lottery and each sub-lottery.

19. A computerized lottery as claimed in claim 18, wherein the lottery is a global lottery and each sub-lottery is held within a geographical area, and the rules allow for the award of a prize to the highest ranked entry per geographical area as well as a prize to the highest ranked entry in the global lottery.

20. A computerized lottery as claimed in claim 19, wherein all entries are ranked and wherein any duplicate rankings are resolved by applying a second order process to ensure each entry has a unique ranking.

21. A computerized lottery as claimed in claim 18, wherein the lottery is a multi-country lottery spanning a number of separate member countries and each sub-lottery is held within a member country, and the rules allow for the award of a prize to the highest ranked entry per member country as well as a prize to the highest ranked entry in the multi-country lottery.

22. A computerized lottery as claimed in claim 18, wherein the lottery is a multi-state lottery spanning a number of separate member states within a country or geographic region and each sub-lottery is held within a member state, and the rules allow for the award of a prize to the highest ranked entry per member state as well as a prize to the highest ranked entry in the multi-state lottery.

23. A computerized lottery as claimed in claim 18, wherein the lottery is a multi-city lottery spanning a number of separate member cities within a country or geographic region and each sub-lottery is held within a member state, and the rules allow for the award of a prize to the highest ranked entry per member state as well as a prize to the highest ranked entry in the multi-city lottery.
